(19) United States
(12) Patent Application Publication
(10) Pub. No.: US 2011/0058871 A1
(43) Pub. Date: Mar. 10, 2011

(54) IMAGE FORMING APPARATUS

(75) Inventor: Eiichi Motoyama, Tokyo (JP)

(73) Assignee: CANON KABUSHIKI KAISHA, Tokyo (JP)

(21) Appl. No.: 12/876,519

(22) Filed: Sep. 7, 2010

(30) Foreign Application Priority Data
Sep. 10, 2009 (JP) 2009-209300(PAT.)
Aug. 31, 2010 (JP) 2010-193937(PAT.)

(51) Int. Cl. G03G 15/00

(52) U.S. Cl. 399/364

(57) ABSTRACT

An image forming apparatus includes an image forming unit configured to form an image onto each sheet, an ejection unit on which the sheet is ejected, a sorting unit configured to sort the sheets ejected on the ejection unit into subsets, and a control unit configured to, when executing a mode for forming images on first sides of the sheets, ejecting the sheets with the images on the first sides, and forming images on second sides of the ejected sheets manually placed on a feeding unit for second-side image formation, control the sorting unit to sort the ejected sheets after first-side image formation into subsets so that the number of sheets in each subset does not exceed a maximum number of sheets stackable on the feeding unit.

### BACKGROUND OF THE INVENTION

1. Field of the Invention

The present invention relates to an image forming apparatus and, in particular, relates to manual duplex printing and printing for preparation of insert sheets.

2. Description of the Related Art

There have been image forming apparatuses having an automatic duplex printing function for automatically performing duplex printing in the apparatus upon duplex printing for printing on the front and rear surfaces of a sheet. According to a typical method for automatic duplex printing, a sheet is inverted in an apparatus and images are sequentially printed on the front and rear surfaces of the sheet. However, a sheet having a thickness or made of a material which is difficult to pass through a conveying path for inverting the sheet cannot be subjected to automatic duplex printing. When an operator wants to perform duplex printing on such a sheet, the operator may use a method for manual duplex printing. According to this method, the front or rear surface, serving as a first side, of a sheet is subjected to printing and, after that, the operator again places the sheet subjected to printing on the first side onto a sheet feeder to print on a second side of the sheet.

For example, Japanese Patent Laid-Open No. 08-334933 and No. 09-146419 disclose related-art image forming apparatuses. In the related art, “manual duplex printing” is performed such that printing is performed on a first side of a sheet and, after that, the sheet subjected to printing on the first side is placed onto a manual sheet feeder in order to perform printing on a second side of the sheet, and guidance is given to an operator before second-side printing. According to the related art, setting of conditions for the second side is simplified. In addition, a placement mistake can be prevented. Accordingly, manual duplex printing can be easily performed on even a sheet which cannot be subjected to automatic duplex printing, for example, thick paper.

In the related-art image forming apparatuses, for manual duplex printing, first-side printing is performed on a sheet fed from a sheet feeding cassette, and second-side printing is performed on the sheet fed from a manual sheet feeder. Accordingly, when first-side printing is performed on sheets whose number exceeds a maximum number of sheets stackable on the manual sheet feeder, sheets which can be stacked on the manual sheet feeder have to be separated from a bundle of sheets subjected to first-side printing before second-side printing.

However, if the sheets are roughly separated from the bundle of sheets subjected to first-side printing and ejected on a sheet output tray, the number of separated sheets is not known. Unfortunately, each image on the first side cannot be properly associated with an image on the second side. For example, it is assumed that a second bundle of 82 sheets is separated from the top of a first bundle of 200 sheets, namely, 119th to 200th sheets are separated from the top of the first sheet bundle and the second bundle is turned upside down and is then placed onto a manual sheet feeder. In this case, the operator is not aware of that the number of placed sheets is 82 and an apparatus does not know the placement of 82 sheets. Normally, images of the 237th and 238th pages should be printed on both sides of the 119th sheet, respectively. However, the association of the pages is not known. Disadvantageously, this results in a remarkable reduction in operability upon manual duplex printing on sheets whose number exceeds the maximum number of sheets stackable on the sheet feeder for second-side printing.

In some cases, an image forming apparatus is combined with an inserter that feeds insert sheets in order to perform a process of producing a bundle of sheets such that insert sheets are placed at specified positions in sheets ejected from the image forming apparatus. In this case, printing for preparing insert sheets is previously performed in some cases. For the printing for preparing insert sheets, if printing is performed on insert sheets whose number exceeds a maximum number of sheets stackable on a sheet feeding tray of the inserter, the same problem as that in manual duplex printing occurs.

### SUMMARY OF THE INVENTION

An aspect of the present invention provides an apparatus including an image forming unit configured to form an image onto each sheet, an ejection unit on which the sheet with the image formed by the image forming unit is ejected, a sorting unit configured to sort the sheets ejected on the ejection unit into subsets, and a control unit configured to, when executing a mode for forming images on first sides of the sheets, ejecting the sheets with the images on the first sides, and forming images on second sides of the ejected sheets manually placed on a feeding unit for second-side image formation, control the sorting unit to sort the ejected sheets after first-side image formation into subsets so that the number of sheets in each subset does not exceed a maximum number of sheets stackable on the feeding unit.

Further features of the present invention will become apparent from the following description of exemplary embodiments with reference to the attached drawings.

### BRIEF DESCRIPTION OF THE DRAWINGS

FIG. 1 is a cross-sectional view of the schematic structure of an image forming apparatus according to a first embodiment of the present invention.

FIG. 2 is a cross-sectional view of the schematic structure of a finisher.

FIG. 3 is a diagram illustrating shifted and ejected sheet bundles on a stack tray.

FIG. 4 is a control block diagram of the image forming apparatus.

FIG. 5 is a diagram illustrating an operation/display unit.

FIGS. 6A to 6C are diagrams illustrating display screens of the operation/display unit.

FIG. 7 is a diagram illustrating a display screen of the operation/display unit.

FIG. 8 is a flowchart illustrating an operation of the image forming apparatus.

FIG. 9 is a flowchart illustrating the operation of the image forming apparatus.

FIGS. 10A and 10B are diagrams illustrating display screens of the operation/display unit.

FIGS. 11A to 11E are diagrams each illustrating a bundle of sheets placed in descending order.

FIGS. 12A to 12E are diagrams each illustrating a bundle of sheets placed in ascending order.

FIGS. 13A to 13B are diagrams each illustrating a bundle of sheets subjected to first-side printing.

FIG. 14 is a flowchart illustrating an operation for insert sheet preparation according to a second embodiment of the present invention.

### DESCRIPTION OF THE EMBODIMENTS

Embodiments of the present invention will be described below.

### First Embodiment

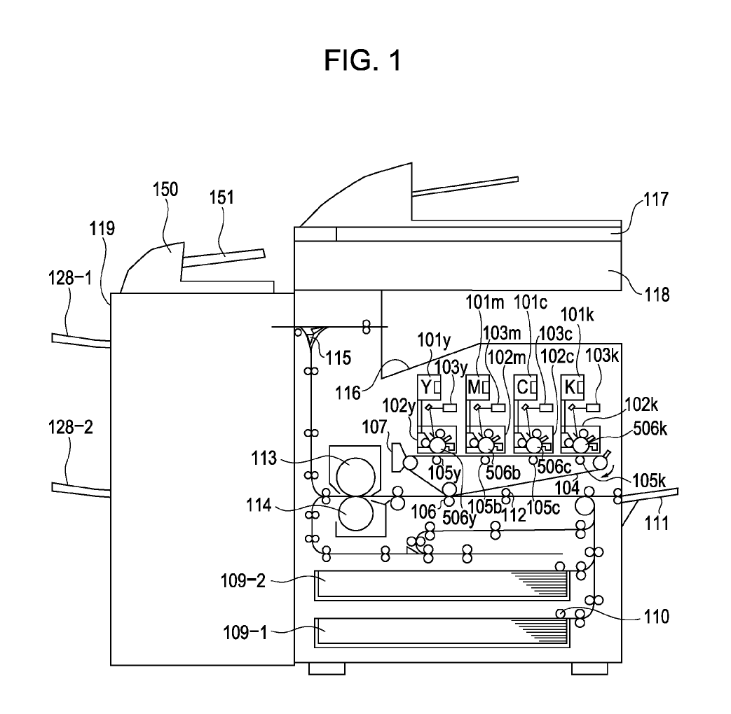

FIG. 1 is a cross-sectional view of the schematic structure of an image forming apparatus according to a first embodiment of the present invention. Processing units 102y to 102k each include, for example, a photosensitive drum, a developing section, a charging roller, and a photosensitive-drum cleaner. The developing sections of the processing units 102y to 102k (i.e., 102y, 102m, 102c, and 102k) are supplied with different color toners of yellow, magenta, cyan, and black from toner bottles 101y to 101k, respectively.

Laser scanner units 103y to 103k expose uniformly charged photosensitive drums 506y to 506k with laser light in accordance with image information, thus forming electrostatic latent images, respectively. The formed electrostatic latent images are processed by the developing sections in the processing units 102y to 102k, respectively, so that toner images are formed. The different color toner images formed on the photosensitive drums are transferred onto an intermediate transfer member 104 while being superimposed on one another. During transfer onto the intermediate transfer member 104, bias voltage is applied to primary transfer rollers 105y to 105k. The toner images transferred on the intermediate transfer member 104 are transferred onto a sheet through secondary transfer roller 106. The toner remaining on the intermediate transfer member 104 without being transferred through the secondary transfer roller 106 is recovered by an intermediate-transfer-member cleaner 107.

Sheets received in sheet cassettes 109-1 and 109-2 are fed through sheet feeding rollers 110, respectively. Each sheet is corrected for skewing by a pair of registration rollers 112 and is then conveyed to the secondary transfer roller 106. The sheet cassettes 109-1 and 109-2 are arranged in two stages as illustrated in FIG. 1. The sheet cassettes 109-1 and 109-2 are each capable of receiving 500 sheets so long as the sheets to be received are plain paper. The material (e.g., plain paper, thick paper, or coated paper) of sheets received in each cassette is set by an operator through an operation and display unit (hereinafter, “operation/display unit”) 501, which will be described later. In this case, the upper cassette will be referred to as a sheet feeder I and the lower cassette will be referred to as a sheet feeder II. On a manual sheet feeder 111 (sheet feeder III), a maximum of 100 sheets having arbitrary size can be stacked (so long as the sheets are plain paper). Specifically, the maximum number of sheets received in each of the sheet feeders I and II is greater than the maximum number of sheets stackable on the sheet feeder III. A sheet on which toner images have been transferred through the secondary transfer roller 106 is heated and pressurized by a fixing roller 113 and a pressure roller 114, thus fixing the toner. The sheet subjected to fixing is conveyed to an inner sheet output tray 116 or a finisher 119 by a sheet ejecting flapper 115. Alternatively, the sheet may be switched back using a conveying path to the inner sheet output tray 116, so that the sheet can be turned upside down and be ejected to the finisher 119.

When a document is fed to a scanning position of a document scanner 118 by an automatic document feeder 117, the document scanner 118 scans the document to read image data. The read image data of the document is subjected to predetermined processing and the resultant image data is transmitted to the laser scanner units 103y to 103k. An inserter 150 includes a tray 151 on which insert sheets to be fed are stacked. The inserter 150 feeds insert sheets from the tray 151 so as to form a bundle of sheets, or a sheet bundle in which each insert sheet is placed between sheets ejected on a stack tray 128-1 or 128-2.

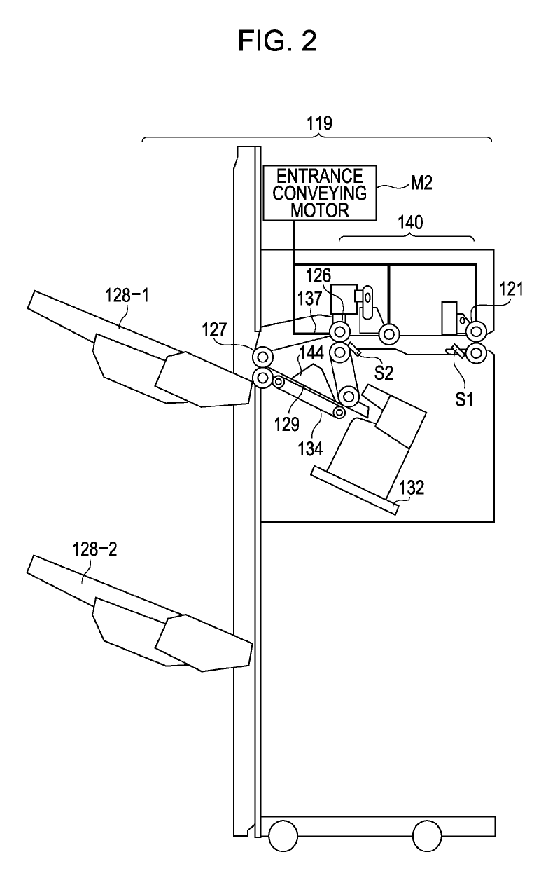

FIG. 2 is a schematic vertical cross-sectional view of driving components of the finisher 119. The finisher 119 includes pairs of conveying rollers 121 and 126 and a pair of bundle conveying rollers 127. The finisher 119 further includes an entrance sensor S1 and an output sensor S2 on a conveying path, the sensors each detecting a sheet. The conveying rollers 121 and 126 are driven by an entrance conveying motor M2. The bundle conveying rollers 127 are vertically separable from each other by movement of a swing unit 137. The swing unit 137 is movable in the vertical direction in the figure to provide three modes, i.e., a self-weighed mode in which the bundle conveying rollers 127 nip a sheet bundle under their own weights, a nip mode in which the rollers 127 tightly nip the sheet bundle, and a separated mode in which the rollers 127 are fully separated from each other.

Before a first sheet is stacked onto a processing tray 129, the bundle conveying rollers 127 operate in the self-weighed mode. After the trailing edge of the sheet passes through the conveying rollers 126 and is stopped at a predetermined position, the bundle conveying rollers 127 rotate in the direction opposite to a sheet conveying direction in which the sheet is conveyed, thus stacking the sheet onto the processing tray 129. The bundle conveying rollers 127 rotate by a predetermined amount and, after that, enter the separated mode to receive the next sheet.

Before a second sheet is stacked, the bundle conveying rollers 127 are in the separated mode. After the trailing edge of the second sheet passes through the conveying rollers 126, the bundle conveying rollers 127 enter the self-weighed mode. After that, the bundle conveying rollers 127 rotate in the direction opposite to the sheet conveying direction in a manner similar to that for the first sheet, thus stacking the second sheet onto the processing tray 129. After that, the bundle conveying rollers 127 rotate by the predetermined amount and then enter the separated mode to receive the next sheet.

A bundle of sheets stacked on the processing tray 129 is subjected to alignment by an aligning unit 144. If a staple mode is set, the sheet bundle is bound by a staple unit 132 at the time when the number of stacked sheets reaches a predetermined number.

After the sheet bundle of one set is stacked and subjected to alignment, the bundle conveying rollers 127 enter the nip mode. The bundle conveying rollers 127 perform an ejecting operation synchronously with a trailing-end assist unit 134 which serves as a mechanism for pushing the trailing end of a sheet bundle, so that the sheet bundle is ejected on the stack tray 128-1 serving as an ejection unit. At this time, the bundle conveying rollers 127 move in the direction (along the axes of the bundle conveying rollers 127) orthogonal to the sheet conveying direction so that the position of each sheet bundle can be changed (shifted) on the stack tray 128-1 from bundle to bundle. A shift unit shifting a sheet in the direction intersecting the sheet conveying direction may be placed between the conveying rollers 121 and the conveying rollers 126 to shift a sheet. In this case, the shift unit shifts a sheet constituting a sheet bundle of one set sheet by sheet.

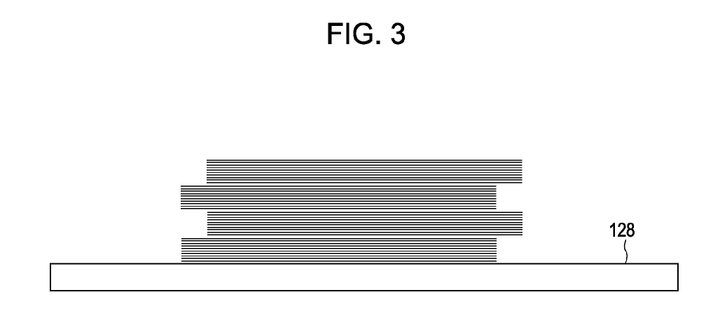

FIG. 3 is a diagram illustrating sheet bundles shifted from bundle to bundle on the stack tray 128, as viewed from the sheet output direction in which sheets are output. Four sheet bundles are stacked on the stack tray 128 such that the sheet bundles are shifted from each other. Accordingly, the operator can easily differentiate each sheet bundle.

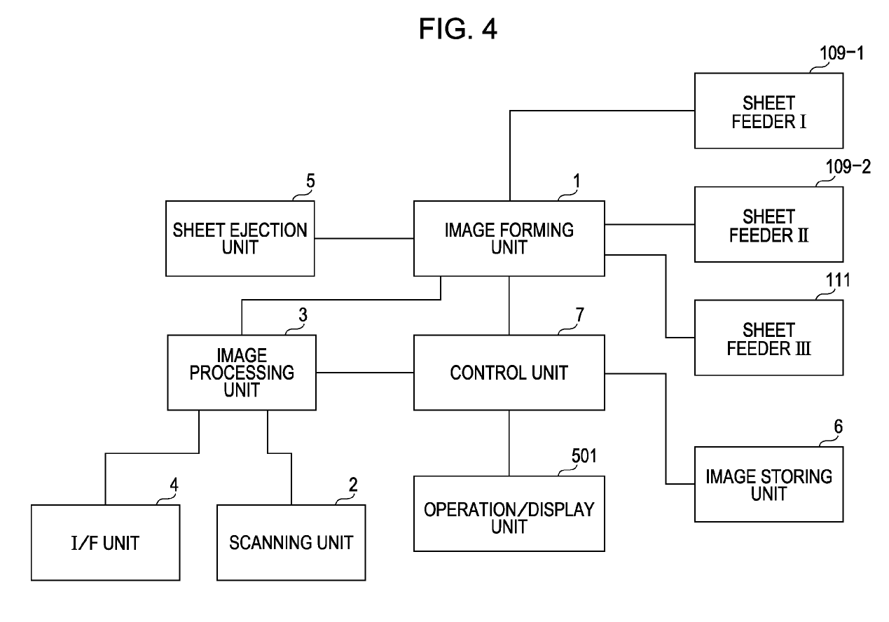

FIG. 4 is a block diagram of the image forming apparatus according to the present embodiment. An image forming unit 1 is a portion configured to form an image onto a sheet and corresponds to the plurality of processing units 102 in FIG. 1. The sheet feeders I, II, and III correspond to the sheet cassettes 109-1 and 109-2 and the manual sheet feeder 111 in FIG. 1, respectively. A sheet ejection unit 5 corresponds to the inner sheet output tray 116 in FIG. 1 and the stack trays 128-1 and 128-2 in the finisher 119. The operation/display unit 501 accepts an input entered using keys by the operator and displays various pieces of information. A scanning unit 2 corresponds to the automatic document feeder 117 and the document scanner 118 in FIG. 2. An interface (I/F) unit 4 receives a print job from a computer. An image processing unit 3 converts an image of a document scanned through the scanning unit 2 or data related to a print job input through the interface unit 4 into data for image formation by the image forming unit 1. An image storing unit 6 stores, for example, an image of a document scanned by the scanning unit 2 or an image input through the interface unit 4. A control unit 7 is configured to control an operation of the image forming apparatus and includes, for example, a central processing unit (CPU), a read-only memory (ROM), and a random access memory (RAM).

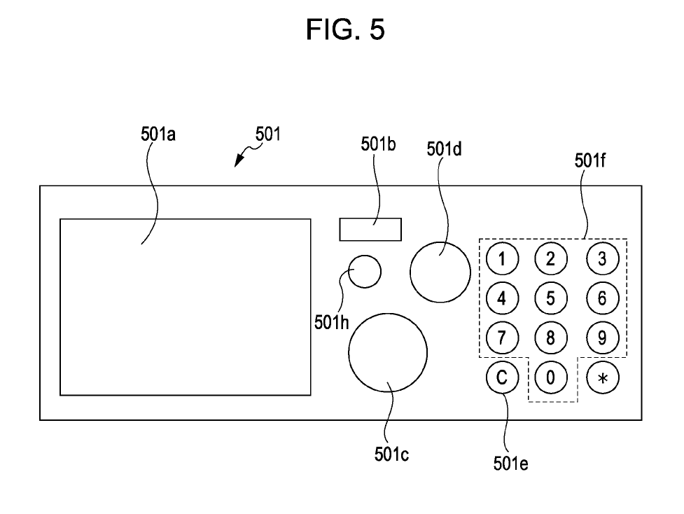

FIG. 5 is a diagram illustrating the operation/display unit 501. By default, a touch panel display 501a displays keys for setting conditions, e.g., the number of copies, a selected sheet size, a scaling factor, a copy density, and finishing and set conditions. A reset key 501b is used to return a set copy mode to a standard mode. A start key 501c is used to enter an instruction to start a copying operation. A stop key 50d is used to interrupt the copying operation which is being performed. A ten key 501f is used to set the number of copies. A clear key 501e is used to reset the number of copies set using the ten key 501f to one.

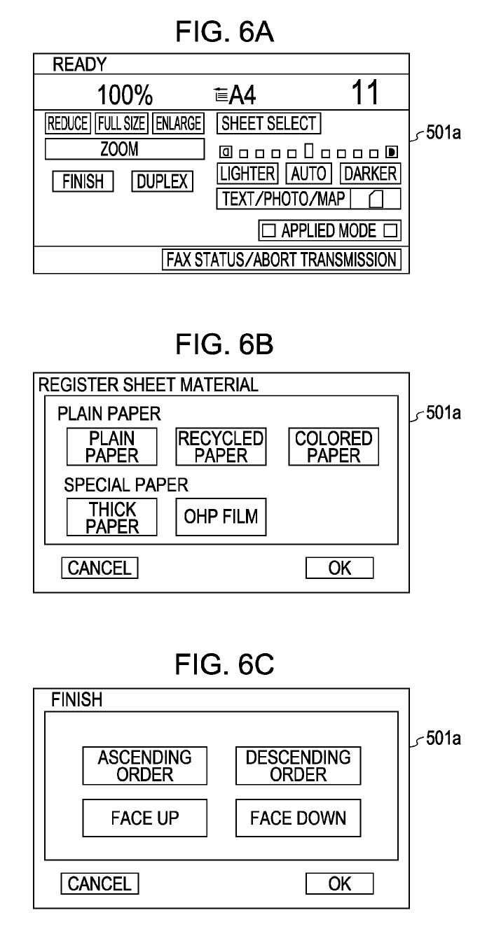

A user mode key 501h is used to set various settings of the image forming apparatus. When the user mode key 501h is pressed, for example, a setting screen as illustrated in FIG. 6B can be displayed to register a material of sheets stored in each sheet feeder.

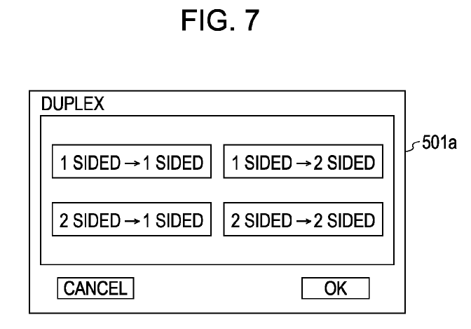

When a “FINISH” key on the touch panel display 501a is pressed, the screen is switched to a screen illustrated in FIG. 6C. On this screen, the operator can select any printing order, i.e., printing in ascending order from the smallest page number to the largest one or printing in descending order from the largest page number to the smallest one. In addition, the operator can select face-up (FU) sheet ejection in which a double-sided printed sheet is ejected such that the surface with the smaller page number of the sheet faces up or face-down (FD) sheet ejection in which a double-sided printed sheet is ejected such that the surface with the smaller page number of the sheet faces down. When a “DUPLEX” key is pressed on the touch panel display 501a, a screen illustrated in FIG. 7 is displayed to prompt the operator to select duplex printing or single-sided printing. On the screen of FIG. 7, any one of a mode for single-sided copying based on a single-sided document, a mode for double-sided copying based on a single-sided document, a mode for single-sided copying based on a double-sided document, and a mode for double-sided copying based on a double-sided document can be selected.

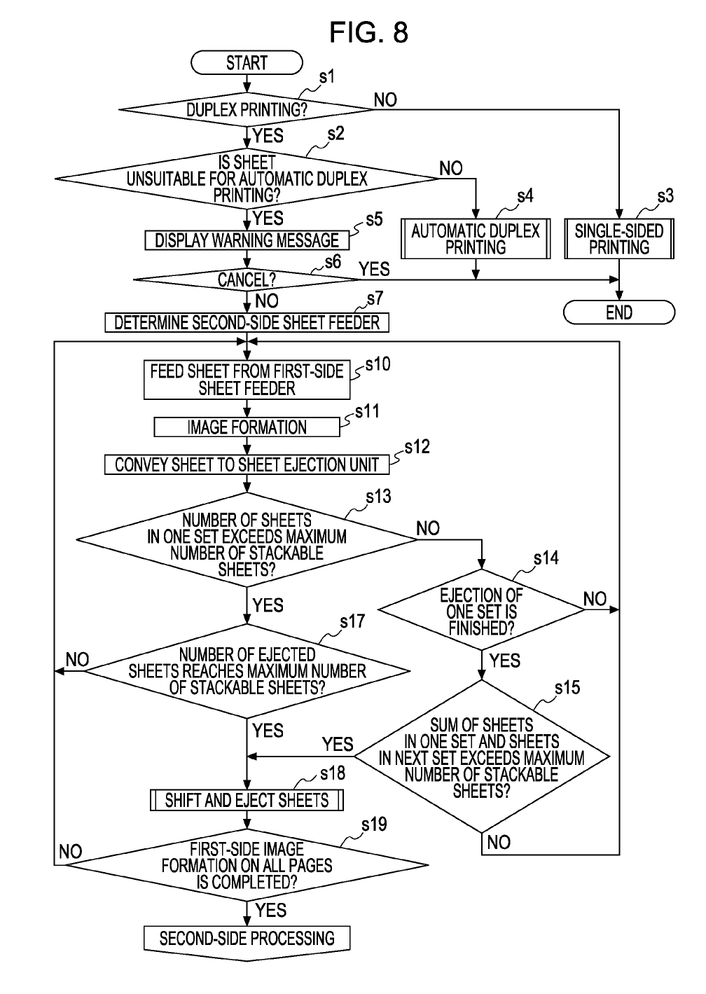

FIG. 8 is a flowchart illustrating a printing operation according to the present embodiment. A process depicted in the flowchart is executed by the control unit 7. In the following description, it is assumed that printing in ascending order and face-down sheet ejection are performed based on a print job transmitted from the computer and input through the interface unit 4.

The control unit 7 first determines whether the print job specifies a duplex printing mode (step s1). If the duplex printing mode is not specified, the control unit 7 performs single-sided printing and terminates the flow (step s3). If the duplex printing mode is specified, the control unit 7 determines whether the material of sheets on a sheet feeder specified by the print job is capable of being conveyed in an inverting path for turning a sheet subjected to first-side printing upside down, namely, whether the material is suitable for automatic duplex printing (step s2). Some sheet materials are not suitable for automatic duplex printing. It is therefore necessary for the operator to perform manual duplex printing. In the present embodiment, when “thick paper” whose basis weight per sheet is at or above a predetermined value is selected as the sheet material, automatic duplex printing cannot be performed using the sheet feeder on which sheets of thick paper are placed. Similarly, it is possible that automatic duplex printing cannot be performed depending on the length or surface properties of a sheet.

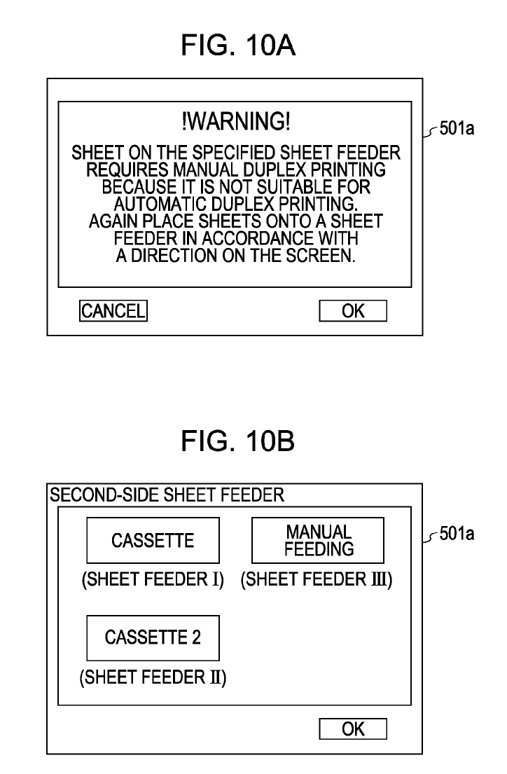

If the material of sheets in the specified sheet feeder is suitable for automatic duplex printing, the control unit 7 performs automatic duplex printing and terminates the process (step s4). If the material of sheets in the specified sheet feeder is not suitable for automatic duplex printing, the control unit 7 allows the operation/display unit 501 to display a message as illustrated in FIG. 10A (step s5). When the operator selects “CANCEL” on the displayed screen (YES in step s6), the control unit 7 terminates the process. When the operator selects “OK” on the displayed screen (NO in step s6), the control unit 7 allows the operation/display unit 501 to display a screen which prompts the operator to select a sheet feeder for second-side printing upon manual duplex printing, as illustrated in FIG. 10B, and determines a sheet feeder on the basis of selection by the operator (step s7).

Step s7 and subsequent steps are steps for manual duplex printing. In the following description, it is assumed that the sheet feeder I (cassette 109-1) is selected as a first-side sheet feeder and the sheet feeder III (manual sheet feeder 111) is selected as a second-side sheet feeder. The control unit 7 allows the sheet feeder I to feed a sheet (step s10), controls the image forming unit 1 so that first-side image formation is performed on the sheet fed from the sheet feeder I (step s11), and ejects the sheet to the sheet ejection unit 5 (step s12).

The control unit 7 determines whether the number N of sheets to be subjected to printing in one set specified by the print job exceeds a maximum number M of sheets (e.g., 100 sheets) stackable on the sheet feeder used for second-side image formation (step s13). If N>M, the control unit 7 determines whether the number of sheets ejected on the sheet ejection unit 5 reaches the maximum number M (step s17). If the number of ejected sheets does not reach the maximum number M, the process returns to step s10 and the first-side image formation is continued. If the number of ejected sheets reaches the maximum number M, the control unit 7 allows a bundle of sheets stacked so far to be ejected so that the bundle is shifted in the direction orthogonal to the sheet conveying direction by a predetermined amount (step s18). After that, the control unit 7 determines whether the first-side image formation on all pages is completed (step s19). If the image formation is not completed, the process returns to step s10. If the image formation is completed, the process proceeds to second-side processing.

If it is determined in step s13 that N<M, the control unit 7 determines whether ejection of sheets in one set is finished (step s14). If printing of one set is not finished, the process returns to step s10. Steps s10 to s14 are repeated until the first-side image formation of one set is finished. If the first-side image formation of one set is finished, the control unit 7 determines whether, if sheets of the next one set are ejected without changing the ejection position on the sheet ejection unit 5, the number of sheets ejected in the same ejection position exceeds the maximum number M of sheets stackable on the manual sheet feeder 111 (step s15). If the number of sheets constituting a bundle does not exceeds the maximum number M, the control unit 7 ejects sheets of the next one set to the sheet ejection unit 5 without changing the ejection position. If the number of sheets constituting a bundle exceeds the maximum number M, the control unit 7 changes the ejection position for sheets of the next one set and ejects the sheets to the sheet ejection unit 5 (step s18). The control unit 7 repeats the above-described process until the first-side image formation on all the sheets is completed.

Consequently, sheet bundles are stacked on the sheet ejection unit 5 such that the number of sheets in each bundle is at or below the maximum number of sheets stackable on the manual sheet feeder 111 and the ejection positions of the sheet bundles differ from each other. Specifically, when the number N of printed sheets in one set is greater than the maximum number M of sheets stackable on the manual sheet feeder 111, sheets of one set are sorted into sheet bundles each including M sheets or less and the sheet bundles are stacked. For example, assuming that one set includes 800 pages (N=400) and the maximum number of sheets stackable on the manual sheet feeder 111 is 100, four sheet bundles each including 100 sheets are stacked on the sheet ejection unit 5 such that the sheet bundles are alternately shifted from each other. On the other hand, when the number N of printed sheets in one set is at or below the maximum number M of sheets stackable on the manual sheet feeder 111, a sheet bundle of one set is stacked or sheet bundles of a plurality of sets are alternately shifted from each other on the sheet ejection unit 5. For example, when images of 80 pages (N=40) in one set are printed to provide six sets, three sheet bundles (each including 80 sheets) each corresponding to two sets are stacked on the sheet ejection unit 5 such that the sheet bundles are alternately shifted from each other. For example, when images of 160 pages (N=80) in one set are printed to provide three sets, three sheet bundles (each including 80 sheets) each corresponding to one set are stacked on the sheet ejection unit 5 such that the sheet bundles are alternately shifted from each other.

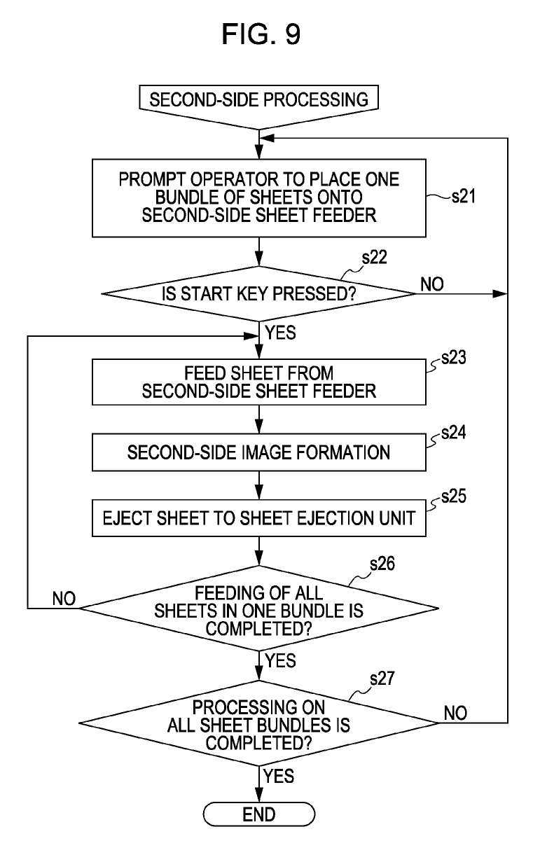

FIG. 9 is a flowchart illustrating second-side printing processing (or process) in the manual duplex printing.

The control unit 7 allows the operation/display unit 501 to display a message which prompts the operator to place one of subsets which are alternately shifted, and stacked on the sheet ejection unit 5 onto the manual sheet feeder 111, serving as the second-side sheet feeder, such that the image-printed surfaces face down and then press the start key 501c (step s21). The control unit 7 waits for pressing the start key 501c (step s22). When the start key 501c is pressed, the control unit 7 allows the manual sheet feeder 111 to feed a sheet from the top of the sheet bundle placed thereon (step s23). The control unit 7 performs second-side image formation (step s24) and ejects the sheet to the sheet ejection unit (step s25). Since the sheet ejection unit 5 in the present embodiment includes the two stack trays 128-1 and 128-2 of the finisher 119 and the inner sheet output tray 116, the sheet is ejected on the tray on which the sheets subjected to first-side printing are not stacked. In an apparatus having only one sheet output tray, it is necessary to temporarily save a plurality of sheet bundles subjected to first-side printing on another place. When the sheet is ejected, the control unit 7 determines whether feeding of all sheets stacked on the manual sheet feeder 111 is completed (step s26). If feeding of all sheets is not completed, the process returns to step s23. Steps s23 to s26 are repeated until the second-side image formation on all of the sheets stacked on the manual sheet feeder 111 is completed. If feeding of all sheets is completed, the control unit 7 determines whether processing on all sheet bundles subjected to first-side printing is completed (step s27). If processing on all bundles is completed, the control unit 7 terminates the manual duplex printing process. If processing on all sheet bundles is not completed, the process returns to step s21. The control unit 7 repeats the process for each bundle until second-side printing on all of the sheet bundles subjected to first-side printing is completed.

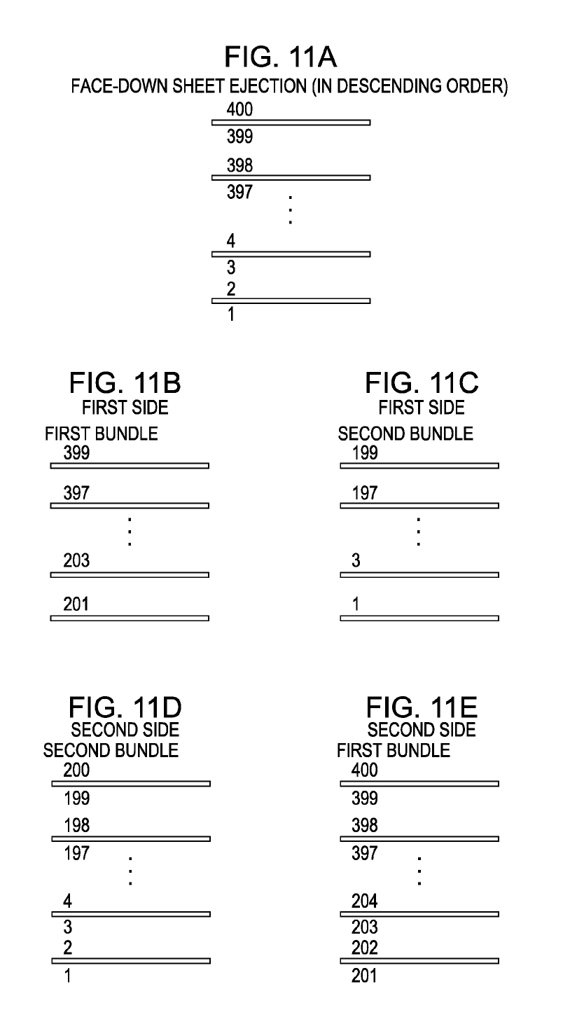

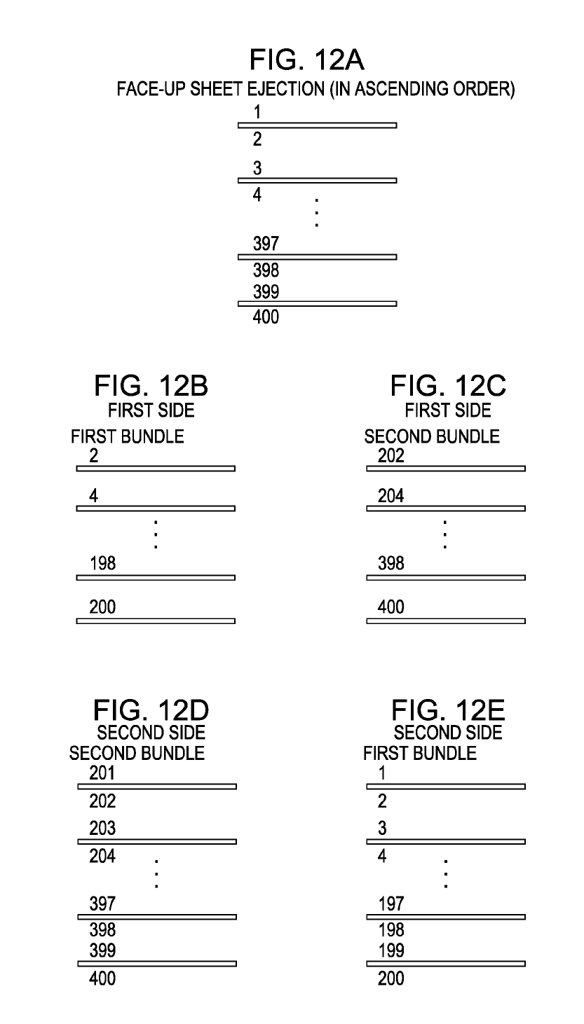

A printing order will now be described. In the following description, it is assumed that images of 400 pages are printed onto 200 sheets by manual duplex printing. FIG. 11A illustrates a case where the sheets subjected to second-side printing are stacked face down (in descending order) on the stack tray 128-2. FIG. 12A illustrates a case where the sheets subjected to second-side printing are staked face up (in ascending order) on the stack tray 128-2. In this specification, “face down” means a stacked state in which the top page is placed at the bottom of the stacked sheets such that the top page faces down and “face up” means a stacked state in which the top page is placed at the top of the stacked sheets such that the top page faces up.

Specifically, upon first-side printing, a first bundle is placed face up on the stack tray 128-1 such that the 201st page, the 203rd page, . . . , the 397th page, and the 399th page are stacked in that order, as illustrated in FIG. 11B. A second bundle is shifted from the first bundle and placed face up on the first bundle such that the first page, the third page, . . . , the 197th page, and the 199th page are stacked in that order, as illustrated in FIG. 11C. In other words, two sheet bundles each including 100 sheets are stacked on the stack tray.

Subsequently, the operator places the second sheet bundle, located on the stack tray 128, face down onto the manual sheet feeder 111 and then presses the start key 501c. Since the sheet on which the image of the first page has been printed is placed face down on the top of the sheet bundle on the manual sheet feeder 111, printing is performed in ascending order from the second page image, so that the printed sheets are stacked on the stack tray 128-2. Consequently, as illustrated in FIG. 11D, the second sheet bundle is placed such that the first page corresponds to the rear surface of the first sheet from the bottom, the second page corresponds to the front surface thereof, the third page corresponds to the rear surface of the second sheet from the bottom, the fourth page corresponds to the front surface thereof, . . . , the 199th page corresponds to the rear surface of the first sheet from the top, and the 200th page corresponds to the front surface thereof. Subsequently, the operator places the first sheet bundle, located on the stack tray 128-1, face down onto the manual sheet feeder 111 and then presses the start key 501c. Since the sheet on which the image of the 201st page has been printed is placed face down on the top of the sheet bundle on the manual sheet feeder 111, printing is performed in ascending order from the 202nd page image, so that the printed sheets are stacked on the second sheet bundle on the stack tray 128-2. The sheets of the first bundle subjected to duplex printing are ejected onto the second sheet bundle in the order illustrated in FIG. 11E.

If sheets based on another print job have been stacked on the stack tray 128-2, serving as an output destination after the second-side printing, it is desirable to temporarily remove the sheets based on the other print job from the stack tray 128-2. Alternatively, a sheet bundle may be shifted and placed onto the sheet bundle, which is left on the stack tray 128-2 and is based on the other job, so that the sheet bundles can be differentiated from each other.

FIGS. 12A to 12E illustrate a case where sheets are ejected face up (in ascending order) onto the stack tray 128-2 after second-side printing. Upon first-side printing, a first bundle is placed face up on the stack tray 128-1 in this order of the second page, the fourth page, . . . , the 198th page, and the 200th page, as illustrated in FIG. 12B. A second bundle is shifted and placed face up on the first sheet bundle in this order of the 202nd page, the 204th page, . . . , the 398th page, and the 400th page, as illustrated in FIG. 12C. In other words, two sheet bundles each including 100 sheets are stacked on the stack tray.

Subsequently, the operator places the second sheet bundle, located on the stack tray 128-1, face down onto the manual sheet feeder 111 and then presses the start key 501c. Since the sheet on which the 400th-page image has been printed is placed face down on the top of the sheet bundle on the manual sheet feeder 111, printing is performed in descending order from the 399th-page image and the printed sheets are stacked onto the stack tray 128-2. Consequently, as illustrated in FIG. 12D, the second sheet bundle is placed such that the 400th page corresponds to the rear surface of the first sheet from the bottom, the 399th page corresponds to the front surface thereof, the 398th page corresponds to the rear surface of the second sheet from the bottom, the 397th page corresponds to the front surface thereof, . . . , the 202nd page corresponds to the rear surface of the first sheet from the top, and the 201st page corresponds to the front surface thereof. Subsequently, the operator places the first sheet bundle, located on the stack tray 128-1, face down onto the manual sheet feeder 111 and then presses the start key 501c. Since the sheet on which the 200th-page image has been printed is placed face down on the top of the sheet bundle on the manual sheet feeder 111, printing is performed in descending order from the 199th-page image and the printed sheets are stacked onto the stack tray 128-2 on which the second sheet bundle has already been placed. Sheets subjected to duplex printing and included in the first sheet bundle are ejected onto the second sheet bundle in the order illustrated in FIG. 12E.

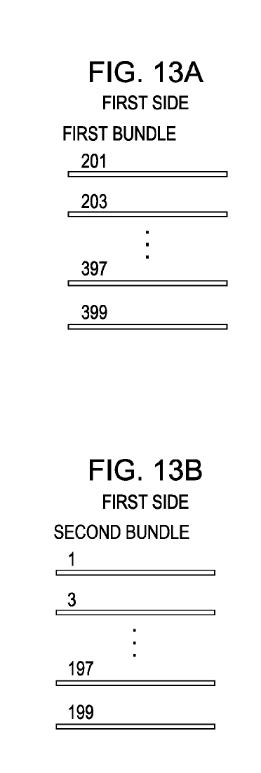

The case illustrated in FIGS. 11A to 11E is premised on that the operator turns a sheet bundle subjected to first-side printing upside down and places the sheet bundle onto the manual sheet feeder 111. In order to place the sheet bundle subjected to first-side printing without being turned upside down, each sheet subjected to fixing may be turned upside down and be then ejected to the finisher 119. As for the printing order upon first-side printing in this case, the first bundle is subjected to printing in descending order from the 399th page and the second bundle is subjected to printing in descending order from the 199th page, as illustrated in FIGS. 13A and 13B.

When the sheet cassette 109-2 is selected as a second-side printing sheet feeder, unlike the manual sheet feeder 111, a sheet is turned upside down and is conveyed to the secondary transfer roller 106 in the structure illustrated in FIG. 1. Accordingly, a sheet bundle subjected to first-side printing has to be placed face up into the sheet cassette 109-2. Consequently, the order of sheet feeding upon second-side printing is reverse to that using the manual sheet feeder 111. Accordingly, the printing upon first-side printing is also reverse to that using the manual sheet feeder 111. For example, in order to eject sheets of a bundle face down onto the stack tray 128-2 after second-side printing, first-side printing is performed on the first sheet bundle in descending order from the 399th page and is performed on the second sheet bundle in descending order from the 199th page.

In the present embodiment, when the number of sheets to be subjected to manual duplex printing exceeds the maximum number of sheets stackable on the manual sheet feeder 111, sheets are ejected such that sheet bundles each including the same number of sheets as the maximum number of stackable sheets are shifted from each other. The operator may designate the number of sheets in the range up to the maximum number of sheets stackable on the manual sheet feeder 111 through the operation/display unit 501. In other words, the operation/display unit 501 functions as a setting unit configured to set the number of sheets separated as one subset.

In addition, although sheets subjected to first-side printing are sorted into bundles (subsets) by shifting and ejecting the sheets in the present embodiment, the sorting may be performed using another method. For example, the sorting may be performed by placing a sheet that serves as a separating sheet between a first bundle and a second bundle. When there are a plurality of sheet output trays, the sorting may be performed by switching the sheet output trays every bundle.

Since the thickness of a sheet bundle varies depending on the thickness of each sheet fed upon first-side printing, the maximum number of sheets stackable on a second-side sheet feeder may be increased or reduced in accordance with the thickness of the sheet. The control unit 7 may determine the thickness of the sheet on the basis of a material of the sheet set through the operation/display unit 501.

In the present embodiment, the image forming apparatus having the automatic duplex printing function has been described as an example. The present invention can also be applied to a case where an image forming apparatus having no automatic duplex printing function performs manual duplex printing.

As described above, according to the present embodiment, after first-side image formation, sheets to be ejected are sorted into bundles so that the number of sheets in each bundle is at or below a maximum number of sheets stackable on a sheet feeder for second-side image formation. The second-side image formation is performed for each sheet bundle. Accordingly, even when the total number of sheets to be subjected to duplex printing exceeds the maximum number of sheets stackable on the sheet feeder for second-side image formation, the apparatus can print so as to automatically properly associate each page for first-side printing with the corresponding page for second-side printing.

### Second Embodiment

A second embodiment of the present invention relates not to the above-described duplex printing but to preparation of insert sheets used in the inserter 150 when post-processing such as binding is performed on-line or off-line. Since the entire structure of an image forming apparatus according to the second embodiment is the same as that in the first embodiment, description thereof is omitted.

The inserter 150 is a device that places an insert sheet between sheets ejected from the main body of the image forming apparatus such that the insert sheet does not pass through the image forming unit. The insert sheet differs from position to position where the insert sheet is placed between sheets from the image forming apparatus. Accordingly, when the image forming apparatus outputs 200 sheets and insert sheets are placed at 50 positions in a bundle of 200 sheets, one set of insert sheets includes 50 sheets.

Each insert sheet is a sheet on which an image has been previously formed. To prepare an insert sheet, a desired image has to be printed onto a sheet, serving as the insert sheet. The insert sheets are placed on the tray 151 of the inserter 150. Accordingly, the same problem as that in the above-described manual duplex printing occurs. Specifically, the number of sheets stackable on the tray 151 of the inserter 150 has an upper limit as in the case of the above-described manual sheet feeder 111. Therefore, when the number of insert sheets in one set exceeds a maximum number of sheets stackable on the tray 151, the insert sheets of one set cannot be placed on the tray 151, serving as an insert sheet feeder, at once. Consequently, when each insert sheet is placed between sheets ejected from the main body of the image forming apparatus, the operability is significantly reduced. For the preparation of the insert sheets, therefore, it is desirable to sort a set of insert sheets into bundles.

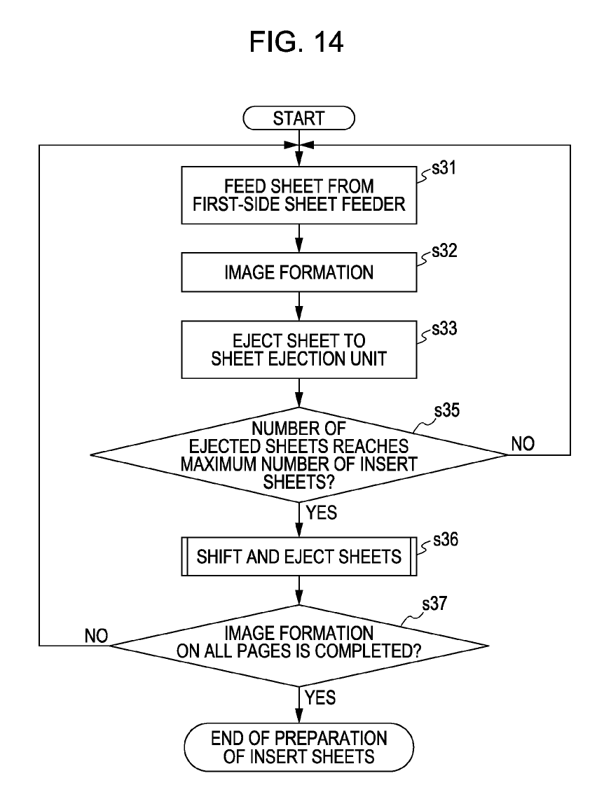

FIG. 14 illustrates a flowchart of a process for preparing insert sheets. It is assumed that sheets to be used as insert sheets are received in the sheet cassette 109-1 (sheet feeder I). The control unit 7 feeds a sheet from the sheet feeder I (step s31), forms an image for an insert sheet onto the fed sheet (step s32), and ejects the sheet to the stack tray 128-1 (step s33). In step s35, the control unit 7 determines whether the number of sheets ejected on the stack tray 128-1 reaches a maximum number of insert sheets. In this case, the maximum number of insert sheets corresponds to the maximum number of sheets stackable on the tray 151 of the inserter 150. The maximum number of insert sheets may be at or below the maximum number of sheets stackable on the tray 151 and be a maximum integer multiple of the number of insert sheets in one set. For example, when the maximum number of sheets stackable on the tray 151 is 100 and the number of insert sheets in one set is 15, the maximum number of insert sheets is 90, as this is the largest integer multiple of 15 that is less than or equal to 100.

If it is determined in step s35 that the number of sheets on the stack tray 128-1 does not reach the maximum number of insert sheets, the process returns to step s31 and formation of remaining images is continued. If the number of sheets on the stack tray 128-1 reaches the maximum number of insert sheets, the control unit 7 performs shift processing for sorting (step s36). After that, the control unit 7 determines whether image formation of the necessary number of insert sheets is completed (step s37). The control unit 7 repeats the process until image formation of all pages is completed. For the preparation of the insert sheets, whether the insert sheets are ejected face down or face up onto the stack tray 128-1 may be determined in accordance with the surfaces of sheets to be ejected in binding as post-processing.

The second embodiment has been described with respect to the case where the image forming apparatus including the inserter prepares insert sheets. The present invention can be applied to a case where an image forming apparatus including no inserter prepares insert sheets. In this case, the maximum number of sheets stackable on a sheet feeder of an inserter used may be entered through an operation/display unit of the image forming apparatus.

As described above, shift processing for sorting is performed each time the number of sheets ejected on the stack tray 128-1 reaches the maximum number of sheets stackable on the tray 151 of the inserter 150. Accordingly, when one bundle of insert sheets is placed onto the tray 151 of the inserter 150, the control unit 7 can allow the insert sheets to be automatically sequentially placed between sheets ejected from the main body of the image forming apparatus. At the completion of feeding all of the insert sheets included in the one bundle placed on the tray 151 of the inserter 150, the next bundle of insert sheets may be placed onto the tray 151.

As described above, according to the present embodiment, even when the number of insert sheets in one set exceeds the maximum number of sheets stackable on the tray of the inserter, the operator can execute an insert job without worrying about the number of insert sheets.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-209300 filed Sep. 10, 2009 and No. 2010-193937 filed Aug. 31, 2010, which are hereby incorporated by reference herein in their entirety.

What is claimed is:

1. An image forming apparatus comprising:
an image forming unit configured to form an image onto each sheet;
an ejection unit on which the sheet with the image formed by the image forming unit is ejected;
a sorting unit configured to sort the sheets ejected on the ejection unit into subsets; and
a control unit configured to, when executing a mode for forming images on first sides of the sheets, ejecting the sheets with the images on the first sides, and forming images on second sides of the ejected sheets manually placed on a feeding unit for second-side image formation, control the sorting unit to sort the ejected sheets after first-side image formation into subsets so that the number of sheets in each subset does not exceed a maximum number of sheets stackable on the feeding unit.

2. The apparatus according to claim 1, further comprising:
a setting unit configured to set the number of sheets in each subset so that the number of sheets in the subset does not exceed the maximum number of stackable sheets.

3. The apparatus according to claim 1, further comprising:
a specifying unit configured to specify a material of the sheet, wherein
the maximum number of stackable sheets varies depending on the specified material.

4. The apparatus according to claim 1, further comprising:
a selecting unit configured to select the feeding unit for second-side image formation independently of a feeding unit for first-side image formation.

5. An apparatus comprising:
an image forming unit configured to form an image onto the sheet fed from a cassette sheet feeding unit or a manual sheet feeding unit;
an ejection unit on which the sheet with the image formed by the image forming unit is ejected;
a sorting unit configured to sort the sheets ejected on the ejection unit into subsets; and
a control unit configured to perform control to allow manual duplex printing so that a first side of each sheet fed from the cassette sheet feeding unit is subjected to image formation and a second side of the sheet ejected on the ejection unit, manually placed on the manual sheet feeding unit, and then fed therefrom is subjected to image formation,
wherein in the manual duplex printing, the control unit controls the sorting unit to sort the ejected sheets after first-side image formation into subsets so that the number of sheets in each subset does not exceed a maximum number of sheets stackable on a manual feeding tray.

6. The apparatus according to claim 5, further comprising:
a setting unit configured to set the number of sheets in each subset so that the number of sheets in the subset does not exceed the maximum number of stackable sheets.

7. The apparatus according to claim 5, further comprising:
a specifying unit configured to specify a material of the sheet, wherein
the maximum number of stackable sheets varies depending on the specified material.

8. An image forming apparatus comprising:
a feeding unit configured to feed each sheet;
an image forming unit configured to form an image onto the fed sheet;
an ejection unit on which the sheet with the image formed by the image forming unit is ejected;
a sorting unit configured to sort the sheets ejected on the ejection unit into subsets; and
a control unit configured to, when executing a mode for preparing insert sheets to be used in an inserter by forming images on the fed sheets and ejecting the sheets on the ejection unit, control the sorting unit so that the number of sheets in each subset does not exceed a maximum number of sheets stackable on a tray of the inserter on which the insert sheets to be fed are placed.

9. The apparatus according to claim 8, wherein the control unit controls the sorting unit so that the number of sheets in each subset is at or below the maximum number of sheets stackable on the tray and is an integer multiple of the number of insert sheets in one set.

10. The apparatus according to claim 8, wherein the image forming apparatus includes the inserter.

11. A method comprising:
forming an image onto each sheet;
sorting sheets ejected on an ejection tray into subsets; and
when executing a mode for forming images on first sides of the sheets, ejecting the sheets with the images on the first sides, and forming images on second sides of the ejected sheets manually placed on a feeding unit for second-side image formation, controlling the sorting to sort the ejected sheets after first-side image formation into subsets so that the number of sheets in each subset does not exceed a maximum number of sheets stackable on the feeding unit.

12. The method according to claim 11, further comprising:
setting the number of sheets in each subset so that the number of sheets in the subset does not exceed the maximum number of stackable sheets.

13. The method according to claim 11, further comprising:
specifying a material of the sheet, wherein the maximum number of stackable sheets varies depending on the specified material.

14. The method according to claim 11, further comprising:
selecting the feeding unit for second-side image formation independently of a feeding unit for first-side image formation.
